(19) United States
(12) Patent Application Publication
(10) Pub. No.: US 2025/0115167 A1
(43) Pub. Date: Apr. 10, 2025

(54) WORK VEHICLE, WORK VEHICLE CONTROL DEVICE, AND CONTROL METHOD

(71) Applicant: Kubota Corporation, Osaka (JP)

(72) Inventors: Yosuke HAYASHI, Sakai-shi (JP); Yuki MINAMIDE, Sakai-shi (JP); Kodai AMITANI, Sakai-shi (JP); Takahiro TAKAKI, Sakai-shi (JP); Kenichi IWAMI, Sakai-shi (JP); Tomoyoshi SAKANO, Sakai-shi (JP); Go TAKAKI, Sakai-shi (JP)

(21) Appl. No.: 18/983,607

(22) Filed: Dec. 17, 2024

Related U.S. Application Data
(63) Continuation of application No. PCT/JP2023/023488, filed on Jun. 26, 2023.

(30) Foreign Application Priority Data
Jun. 28, 2022 (JP) 2022-103773

(51) Int. Cl. B60L 58/33; H01M 8/04228; H01M 8/04303; H01M 8/04701

(52) U.S. Cl. CPC B60L 58/33; H01M 8/04228; H01M 8/04303; H01M 8/04708; B60L 2200/40

(57) ABSTRACT

A work vehicle includes a fuel cell module including a fuel cell stack, at least one fuel tank to store fuel to be supplied to the fuel cell stack, a motor connected to the fuel cell module, a travel device drivable by the motor, a power take-off shaft drivable by the motor and to which an implement is connected, and a controller. In response to an operation stop command, the controller is configured or programmed to stop supply of the fuel or the oxidizing gas to the fuel cell module, and then rotate the motor with power from the motor to the travel device halted, thus discharging residual charge in circuitry connected to the motor.

### CROSS REFERENCE TO RELATED APPLICATIONS

This application claims the benefit of priority to Japanese Patent Application No. 2022-103773 filed on Jun. 28, 2022 and is a Continuation Application of PCT Application No. PCT/JP2023/023488 filed on Jun. 26, 2023. The entire contents of each application are hereby incorporated herein by reference.

### BACKGROUND OF THE INVENTION

### 1. Field of the Invention

The present disclosure relates to work vehicles, work vehicle controllers, and control methods.

### 2. Description of the Related Art

In the field of motor vehicles, where the main purpose is to transport “people” or “objects,” electric vehicles (EVs) are becoming increasingly popular. In these vehicles, the driving force (traction) is generated by an electric motor (hereinafter referred to as “motor”) instead of an internal combustion engine.

On the other hand, there is a need to reduce the amount of carbon dioxide (CO₂) emitted by work vehicles, such as tractors used in agricultural fields, to realize a decarbonized society. Unlike typical automobiles, work vehicles such as tractors need to tow implements, which are work machines, to perform agricultural tasks such as plowing. Therefore, to achieve the electrification of work vehicles, there are issues to be solved that differ from those of passenger cars.

Japanese Laid-Open Patent Publication No. 2002-225577 discloses a tractor that includes a fuel cell (FC) power generation system and a motor, while maintaining the structure of a conventional engine-driven tractor with minimal alteration.

Japanese Laid-Open Patent Publication No. 2022-46376 discloses a vehicle equipped with a fuel cell system. This vehicle performs a discharge process to consume the residual electric charge remaining in the high-voltage system installed in the vehicle when the ignition is turned OFF to power down the entire vehicle system. The residual electric charge in the high-voltage system is the charge remaining in the circuitry, excluding the storage battery, and may be, for example, charge remaining in capacitors included in the circuitry. In the discharge process, the charge is consumed by a heater that heats water in a water tank that stores water generated by fuel cell power generation.

### SUMMARY OF THE INVENTION

Example embodiments of the present disclosure provide techniques to efficiently discharge residual electric charge when operation is stopped in a work vehicle equipped with a fuel cell module.

A work vehicle according to an exemplary and non-limiting example embodiment of the present disclosure, includes a fuel cell module including a fuel cell stack, at least one fuel tank to store fuel to be supplied to the fuel cell stack, a motor connected to the fuel cell module, a travel device drivable by the motor, a power take-off shaft drivable by the motor and configured to connect an implement, and a controller configured or programmed to, in response to an operation stop command, stop supply of fuel or oxidizing gas to the fuel cell module, and then rotate the motor with power from the motor to the travel device halted, so as to discharge residual electric charge in circuitry connected to the motor.

Example embodiments of this disclosure may be implemented using apparatuses, systems, methods, integrated circuits, computer programs, or computer-readable non-transitory storage media, or any combination thereof. The computer-readable storage media may be inclusive of volatile storage media or non-volatile storage media. The apparatuses may include multiple devices. In the case where the apparatuses include two or more devices, these two or more devices may be provided within a single piece of equipment or may be separately provided in two or more pieces of equipment.

According to example embodiments of this disclosure, discharging residual charge can be effectively performed when operation is stopped.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a plan view schematically showing a basic configuration example of a work vehicle according to this disclosure.

FIG. 2 is a diagram showing a basic configuration example of a fuel cell power generation system mounted on the work vehicle.

FIG. 3 is a block diagram schematically showing an example of electrical connections and power transmission between components of the work vehicle according to this disclosure.

FIG. 4 is a block diagram schematically showing paths of electrical signals (thin solid lines) and coolant paths (dotted lines) between components in the work vehicle according to this disclosure.

FIG. 5 is a perspective view schematically showing a configuration example of a work vehicle in an example embodiment of this disclosure.

FIG. 6 is a side view schematically showing a configuration example of a work vehicle in an example embodiment of this disclosure.

FIG. 7 is a flowchart showing an example of a discharge process of the work vehicle.

FIG. 8 is a flowchart showing another example of a discharge process of the work vehicle.

FIG. 9 is a flowchart showing yet another example of a discharge process of the work vehicle.

### DETAILED DESCRIPTION OF THE EXAMPLE EMBODIMENTS

The following describes example embodiments of the present disclosure. However, excessively detailed explanations may be omitted. For example, detailed explanations of well-known matters and repetitive explanations of substantially identical configurations may be omitted. This is to avoid the following description from becoming unnecessarily redundant and to facilitate understanding by those skilled in the art. The inventors provide the attached drawings and the following description to enable those skilled in the art to fully understand this disclosure, and do not intend to limit the subject matter described in the claims by these drawing and description. In the following description, the same reference numerals are used for components with the same or similar functions.

The following example embodiments are illustrative and not limiting. The technologies disclosed herein are not restricted to the following example embodiments. For instance, the numerical values, shapes, materials, steps, the order of those steps, screen layouts, and other elements shown in the following example embodiments are merely examples. Various modifications can be made as long as no technical contradictions arise. Additionally, different feature, elements, characteristics, etc., of the example embodiments may be combined as long as there are no technical contradictions.

In this disclosure, the term “work vehicle” refers to a vehicle used to perform a task at a work site. A “work site” includes any place where work is carried out, such as a field, forest, or construction site. A “field” refers to any place where agricultural work is performed, such as an orchard, farm, paddy field, grain farm, or pasture. A work vehicle may include an agricultural machine such as a tractor, rice planter, combine harvester, vehicle for crop management, or riding mower, as well as a non-agricultural vehicle such as a construction work vehicle or snowplow. The work vehicles described in this disclosure may be equipped with an implement (also called a “work machine” or “work device”) attached to at least one of its front and rear portions, depending on the nature of the work. Travel of a work vehicle while performing a task may be referred to as “tasked travel.”

An “agricultural machine” refers to a machine for agricultural application. Examples of agricultural machines include tractors, harvesters, rice planters, vehicles for crop management, vegetable transplanters, mowers, seeders, spreaders, and agricultural mobile robots. Not only may a work vehicle such as a tractor function as an “agricultural machine” on its own, but also the entire combination of a work vehicle and an implement attached to or towed by the work vehicle may function as an “agricultural machine.” An agricultural machine performs agricultural work on the ground in a field, such as tilling, seeding, pest control, fertilizing, planting crops, or harvesting.

An example of the basic configuration and operation of a work vehicle according to this disclosure will be described. The work vehicle described below includes a motor and a fuel cell power generation system (hereinafter referred to as “FC power generation system”) that generates the power necessary to drive the motor.

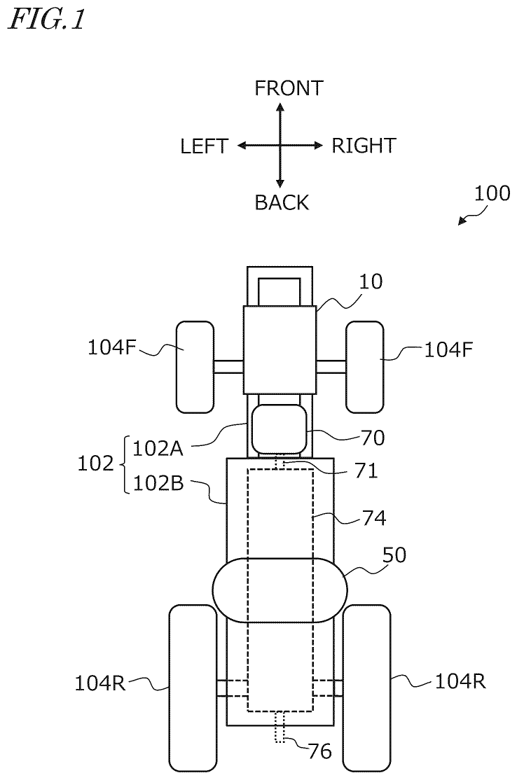

FIG. 1 is a schematic plan view showing an example of the basic configuration of a work vehicle 100 according to this disclosure. In this disclosure, the direction in which the work vehicle 100 travels straight forward is referred to as the “forward direction,” and the direction in which it travels straight backward is referred to as the “backward direction.” In a plane parallel to the ground, the direction extending perpendicularly to the right of the “forward direction” is referred to as the “right direction,” and the direction extending perpendicularly to the left is referred to as the “left direction.” In FIG. 1, the “forward direction,” “backward direction,” “right direction,” and “left direction” are indicated by arrows labeled “front,” “back,” “right,” and “left” respectively. Both the forward and backward directions may be collectively referred to as the “front-back direction.”

The work vehicle 100 illustrated in this example is, for instance, a tractor, which defines and functions as an example of agricultural machinery. The technologies disclosed herein are not limited to work vehicles such as tractors and may be applied to other types of work vehicles. The work vehicle 100 is configured to attach or tow an implement and travel within a field while performing agricultural tasks appropriate to the type of implement. Additionally, the work vehicle 100 is configured to travel both within and outside the field (including on roads) with the implement raised or without an implement attached.

The work vehicle 100, like a conventional tractor, includes a vehicle frame (vehicle body) 102 that rotatably supports left and right front wheels 104F and left and right rear wheels 104R. The vehicle frame 102 includes a front frame 102A where the front wheels 104F are mounted, and a transmission case 102B where the rear wheels 104R are mounted. The front frame 102A is fixed to the front portion of the transmission case 102B. The front wheels 104F and rear wheels 104R may be collectively referred to as wheels 104. Strictly speaking, the wheels 104 refer to wheel rims with tires attached. In this disclosure, the term “wheel” generally refers to the entire assembly of the “wheel rim and tire.” Either or both of the front wheels 104F and rear wheels 104R may be replaced with a plurality of wheels equipped with endless tracks (crawlers) instead of wheels with tires. In this specification, the term “travel device” may collectively refer to the left and right front wheels 104F and left and right rear wheels 104R, the axles that rotate these four wheels, and the braking devices (brakes) that apply braking to each axle.

In the example shown in FIG. 1, the work vehicle 100 includes a fuel cell module (FC module) 10 and a motor 70, which are directly or indirectly supported by the front frame 102A. The FC module 10 includes a fuel cell stack (FC stack) and functions as an onboard power generator that generates electricity from fuel, as will be described later. Hereinafter, the terms “FC module” or “FC stack” may simply be referred to as “fuel cell.”

The motor 70 is electrically connected to the FC module 10. The motor 70 converts the electric power generated by the FC module 10 into mechanical motion (power) to produce the driving force (traction) necessary for the work vehicle 100 to travel. An example of the motor 70 is an AC synchronous motor. Since the FC stack of the FC module 10 generates direct current, when the motor 70 is an AC synchronous motor, a group of electrical circuits, including an inverter device, is installed between the FC stack and the motor 70 to convert the direct current to alternating current. A portion of such electrical circuit group may be inside the FC module 10, while another portion of the electrical circuit group may be attached to the motor 70 as a motor drive circuit.

The motor 70 includes an output shaft 71 that rotates. The torque of the output shaft 71 is transmitted to the rear wheels 104R through mechanical parts such as a transmission (gearbox) and a rear wheel differential gear device installed inside the transmission case 102B. In other words, the power generated by the motor 70, which serves as the power source, is transmitted to the rear wheels 104R through a power transmission system (drivetrain) 74 including the transmission installed in the transmission case 102B. For this reason, the “transmission case” may also be referred to as a “mission case.” In four-wheel drive mode, a portion of the power of the motor 70 is also transmitted to the front wheels 104F. The power of the motor 70 may be used not only to drive the work vehicle 100 but also to control or operate implements. Specifically, a power take-off (PTO) shaft 76 is provided at the rear end of the transmission case 102B. The PTO shaft 76 is drivable by the motor 70 and is configured to be connected to an implement. The torque from the output shaft 71 of the motor 70 is transmitted to the PTO shaft 76. Implements attached to or towed by the work vehicle 100 is configured to receive power from the PTO shaft 76 to perform various work-related operations. The motor 70 and the power transmission system 74 may collectively be referred to as an electric powertrain.

Thus, the work vehicle 100 disclosed herein does not includes an internal combustion engine such as a diesel engine, but includes the FC module 10 and the motor 70. Additionally, the output shaft 71 of the motor 70 is mechanically coupled to the power transmission system 74, including the transmission in the transmission case 102B. The motor 70 efficiently generates torque over a relatively wide range of rotational speeds compared to an internal combustion engine. However, by utilizing the power transmission system 74, including the transmission, it becomes easier to adjust the torque and rotational speed from the motor 70 over an even wider range by performing multi-stage or continuously variable speed change operations. This configuration allows for efficient execution of not only the travel of the work vehicle 100 but also various operations using implements.

Depending on the application or size of the work vehicle 100, some functions of the power transmission system 74 may be omitted. For example, a portion or an entirety of the transmission responsible for speed change functions may be omitted. The number and mounting position of motors 70 are also not limited to the example shown in FIG. 1.

The work vehicle 100 includes at least one fuel tank 50 that stores fuel to be supplied to the FC module 10. For simplicity, FIG. 1 shows one fuel tank 50. In some example embodiments, a plurality of fuel tanks 50 may be housed in a tank case to define a fuel tank module. The fuel tank 50 is supported by structural elements fixed to the vehicle frame 102A described later. The FC module 10 and the fuel tank 50 are connected by piping and open/close valves, and similar components, defining an FC power generation system mounted on a vehicle. The configuration and operation of the FC power generation system will be described later.

The work vehicle 100 in the example embodiments described later includes a seat for a driver, hereinafter referred to as “a driver seat,” supported by the vehicle frame 102. The driver seat may be enclosed by a cabin supported by the vehicle frame 102. In the example embodiments described later, the FC module 10 is positioned in front of the driver seat, and the fuel tank 50 is positioned above the driver seat. Such FC module 10 and fuel tank 50 are housed in at least one “enclosure.” The “enclosure” functions as a housing, for example, and plays a role in protecting the FC module 10 and fuel tank 50 from sunlight exposure and wind and rain. Additionally, such an enclosure is designed to control the spread of fuel gas into the atmosphere and to facilitate the detection of fuel gas when fuel gas leaks from the FC module 10 or fuel tank 50.

The FC module 10 may be housed in a front housing called a “bonnet,” for example. The front housing is a portion of the “enclosure.” The front housing is supported by the front portion of the vehicle frame 102 (front frame 102A). The fuel tank 50 is housed in a tank case, as mentioned earlier. The tank case is directly or indirectly supported by the vehicle frame 102.

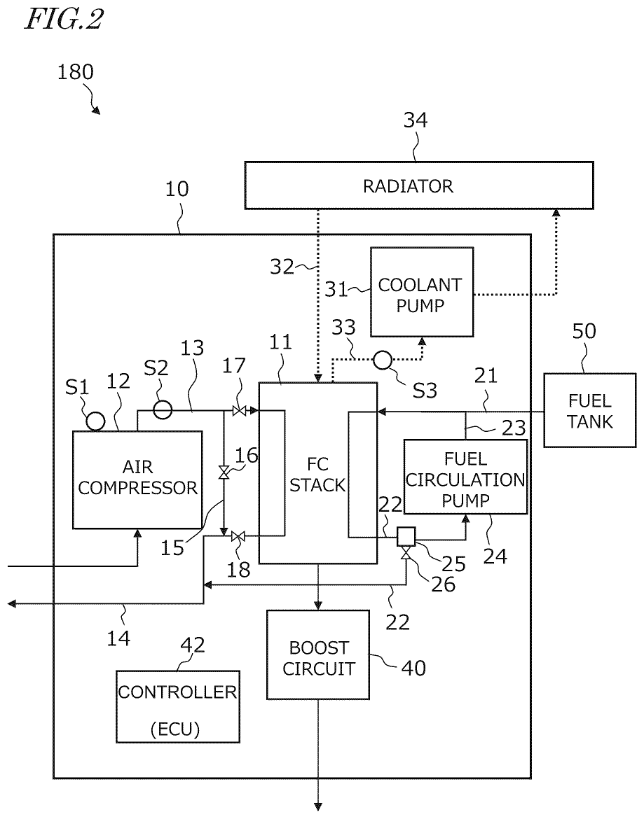

Next, referring to FIG. 2, a basic configuration example of the FC power generation system 180 mounted on the work vehicle 100 will be explained.

The FC power generation system 180 shown in FIG. 2 functions as an onboard power generation system in the work vehicle 100 of FIG. 1. The electric power generated by the FC power generation system 180 is used not only for the travel of the work vehicle 100 but also for the operation of implements towed or attached to the work vehicle 100.

The FC power generation system 180 in the illustrated example includes the FC module 10 and at least one fuel tank 50 that stores fuel to be supplied to the FC module 10. The FC power generation system 180 also includes a radiator device 34 to cool the FC module 10.

The FC module 10 includes main components such as a fuel cell stack (FC stack) 11, an air compressor 12, a fuel circulation pump 24, a coolant pump 31, a boost circuit 40, and a controller 42. These components are housed within the casing of the FC module 10 and are connected to each other through electrical or fluid communication.

The FC stack 11 generates electric power through an electrochemical reaction between the fuel, referred to as “anode gas” and the oxidizing gas, referred to as “cathode gas.” In this example, the FC stack 11 includes polymer electrolyte fuel cells. The FC stack 11 has a stack structure in which a plurality of single cells (fuel cells elements) are stacked. A single cell includes, for example, an electrolyte membrane including an ion exchange membrane, an anode electrode on one side of the electrolyte membrane, a cathode electrode on the other side of the electrolyte membrane, and a pair of separators sandwiching the anode electrode and cathode electrode on both sides. The voltage generated in a single cell is, for example, less than 1 volt. Therefore, in the FC stack 11, for instance, more than 300 single cells are connected in series to generate a voltage of several hundred volts.

Anode gas is supplied to the anode electrode of the FC stack 11. The anode gas is called “fuel gas” or simply “fuel.” In the example embodiments of this disclosure, the anode gas (fuel) is hydrogen gas. Cathode gas is supplied to the cathode electrode. The cathode gas is an oxidizing gas such as air. The anode electrode is called the fuel electrode, and the cathode electrode is called the air electrode.

At the anode electrode, the electrochemical reaction shown in the following equation (1) occurs.

2H₂→4H⁺+4e⁻ equation (1)

At the cathode electrode, the electrochemical reaction shown in the following equation (2) occurs.

4H⁺+4e⁻+O₂→2H₂O equation (2)

Overall, the reaction shown in the following equation (3) occurs.

2H₂+O₂→2H₂O equation (3)

The anode gas after being used in the above reaction is called “anode off-gas”, and the cathode gas after being used in the reaction is called “cathode off-gas.”

The air compressor 12 supplies air taken from the outside as cathode gas to the cathode electrode of the FC stack 11. The cathode gas supply system including the air compressor 12 includes a cathode gas supply pipe 13, a cathode off-gas pipe 14, and a bypass pipe 15. The cathode gas supply pipe 13 flows cathode gas (air) supplied from the air compressor 12 to the cathode electrode of the FC stack 11. The cathode off-gas pipe 14 flows cathode off-gas discharged from the FC stack 11 to the outside air. The bypass pipe 15 branches from the cathode gas supply pipe 13 downstream of the air compressor 12, bypasses the FC stack 11, and connects to the cathode off-gas pipe 14. A control valve 16 is provided on the bypass pipe 15 to adjust the flow rate of cathode gas flowing through the bypass pipe 15. A shut-off valve 17 is provided on the cathode gas supply pipe 13 to selectively block the inflow of cathode gas to the FC stack 11. A pressure regulating valve 18 is provided on the cathode off-gas pipe 14 to adjust the back pressure of the cathode gas.

The cathode gas supply system of the FC module 10 includes a rotation speed detection sensor S1 that detects the rotation speed of the air compressor 12 and a gas flow rate detection sensor S2 that detects the flow rate of cathode gas flowing through the cathode gas supply pipe 13. The control valve 16, shut-off valve 17, and pressure regulating valve 18 are, for example, electromagnetic valves.

The fuel circulation pump 24 supplies fuel gas (anode gas) sent from the fuel tank 50 to the anode electrode of the FC stack 11. The anode gas supply system including the fuel circulation pump 24 includes an anode gas supply pipe 21, an anode off-gas pipe 22, and a circulation path 23. The anode gas supply pipe 21 flows anode gas supplied from the fuel tank 50 to the anode electrode of the FC stack 11. In the example embodiments of this disclosure, the fuel tank 50 is a hydrogen tank that stores high-pressure hydrogen gas, for example.

The anode off-gas pipe 22 flows anode off-gas discharged from the FC stack 11. The anode off-gas is led through the anode off-gas pipe 22 to a gas-liquid separator 25 in which moisture is removed. The anode off-gas with moisture removed returns to the anode gas supply pipe 21 through the circulation path 23 by the fuel circulation pump 24. The anode off-gas circulating through the circulation path 23 can be discharged through the anode off-gas pipe 22 by opening an exhaust valve 26. Moisture accumulated in the gas-liquid separator 25 can be discharged through the anode off-gas pipe 22 by opening the exhaust valve 26. The exhaust valve 26 is, for example, an electromagnetic valve. In the example shown in the figure, the anode off-gas pipe 22 is connected to the cathode off-gas pipe 14. By adopting this configuration, it is possible to improve the utilization efficiency of the anode gas by circulating the anode off-gas containing unreacted anode gas that did not contribute to the electrochemical reaction and supplying it again to the FC stack 11.

To enhance the performance of the FC stack 11, temperature control is important. When generating electricity through the reaction of producing water from hydrogen gas and oxygen gas, heat is also generated, necessitating cooling. FIG. 2 shows a coolant circulation system including a coolant pump 31 for the FC stack 11, but as described later, cooling circulation systems for other electrical equipment may also be provided. Note that the air compressor 12, fuel circulation pump 24, and coolant pump 31 included in the FC module 10 are drivable by individual built-in motors. These motors are also electrical equipment.

The coolant circulation system including the coolant pump 31 shown in FIG. 2 includes a coolant supply pipe 32, a coolant discharge pipe 33, a radiator device 34, and a temperature sensor S3. This coolant circulation system is configured to adjust the temperature of the FC stack 11 within a predetermined range by circulating coolant through the FC stack 11. The coolant is supplied to the FC stack 11 through the coolant supply pipe 32. The supplied coolant flows through a coolant path between single cells and is discharged into the coolant discharge pipe 33. The coolant discharged into the coolant discharge pipe 33 flows to the radiator device 34. The radiator device 34 performs heat exchange between the incoming coolant and the outside air to release heat from the coolant, and then resupplies the cooled coolant to the coolant supply pipe 32.

The coolant pump 31 is provided on either the coolant supply pipe 32 or the coolant discharge pipe 33 to pump coolant to the FC stack 11. A coolant bypass flow path may be provided between the coolant discharge pipe 33 and the coolant supply pipe 32. In that case, a flow dividing valve is provided at the branching point at which the coolant bypass flow path branches from the coolant discharge pipe 33. The flow dividing valve is configured to adjust the flow rate of coolant flowing through the bypass flow path. The temperature sensor S3 detects the temperature of the coolant flowing through the coolant discharge pipe 33.

The coolant used to cool the FC stack 11 is circulated through the flow path by an electric coolant pump 31. A coolant control valve may be provided downstream of the FC stack 11. The coolant control valve adjusts the ratio of coolant flowing to the radiator device 34 and coolant bypassing the radiator device 34, enabling more accurate control of the coolant temperature. Furthermore, by controlling the liquid delivery amount by the coolant pump, it is also possible to control the coolant temperature difference between the inlet and outlet of the FC stack 11 to be within a desired range. The temperature of the coolant in the FC stack 11 may be controlled to be around 70° C., for example, which is a temperature where the power generation efficiency of the FC stack 11 is high.

The coolant flowing through the FC stack 11 preferably has higher insulation properties compared to the coolant used to cool ordinary electrical equipment. Since voltages exceeding 300 volts can occur in the FC stack 11, increasing the electrical resistance of the coolant allows for the suppression of current leakage through the coolant or devices such as the radiator device 34. The electrical resistance of the coolant may decrease as the coolant is used. This is because ions dissolve into the coolant flowing through the FC stack 11. To remove such ions from the coolant and increase insulation property, it is desirable to place an ion exchanger in the coolant flow path.

The boost circuit 40 is configured to increase the voltage output by the FC stack 11 through power generation to a desired level. The subsequent stage of the boost circuit 40 is connected to the high-voltage electrical circuit including an inverter device for motor drive. The subsequent stage of the boost circuit 40 may also be connected in parallel to the low-voltage electrical circuit via a step-down circuit.

The controller 42 may include an electronic control unit (ECU) configured or programmed to control power generation by the FC module 10. The controller 42 is configured or programmed to detect or estimate the operating state of the FC power generation system 180 based on signals output from various sensors. The controller 42 is configured or programmed to control power generation by the FC stack 11 by regulating the operation of the air compressor 12, fuel circulation pump 24, coolant pump 31, and various valves, based on the operating state of the FC power generation system 180 and instructions output from a higher-level computer or other ECUs. The controller 42 includes, for example, a processor, a storage device, and an input/output interface.

In the following description, for simplicity, “anode gas” may be referred to as “fuel gas” or “fuel,” and “anode gas supply pipe” may be referred to as “piping.”

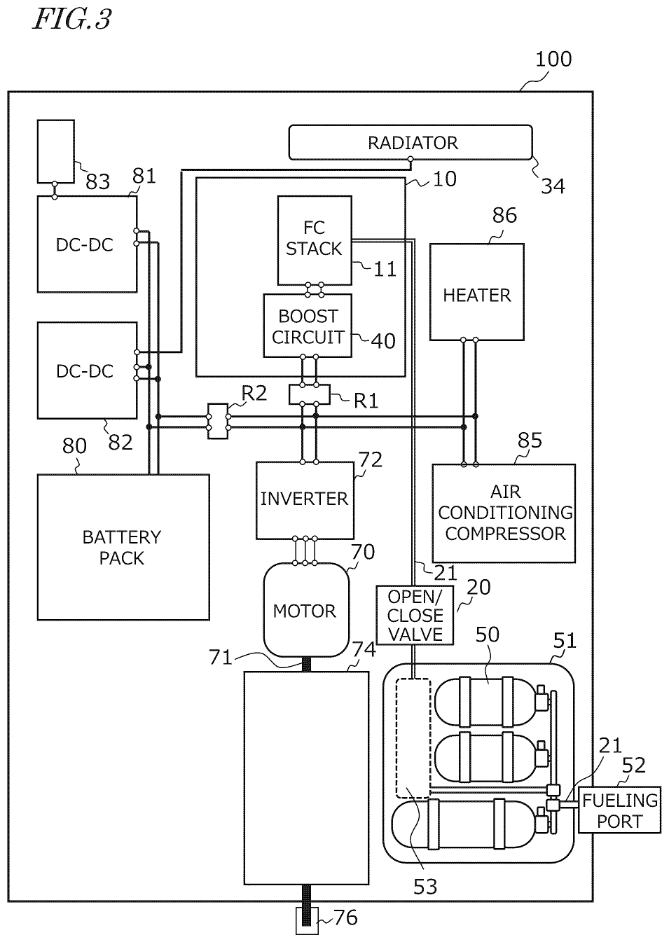

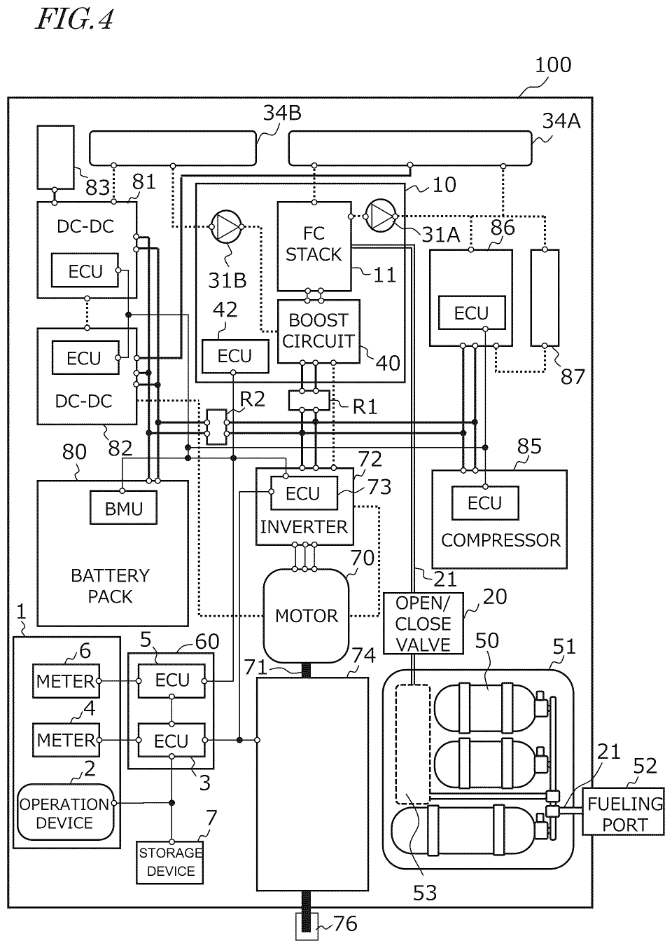

Next, referring to FIGS. 3 and 4, a configuration example of the system of the work vehicle 100 according to this disclosure will be described. FIG. 3 is a block diagram schematically showing an example of electrical connections and power transmission between components of the work vehicle 100 according to this disclosure. FIG. 4 is a block diagram showing a more detailed configuration than the example in FIG. 3. FIG. 4 schematically shows the paths of electrical signals (thin solid lines) and coolant (dotted lines) between components in the work vehicle 100.

First, referring to FIG. 3, an example of the electrical connections and power transmission between components will be described. Electrical connections include both high-voltage and low-voltage systems. High-voltage electrical connections provide, for example, the power supply voltage for inverter devices. Low-voltage electrical connections provide, for example, the power supply voltage for electronic components that operate at relatively low voltages.

In the example shown in FIG. 3, the work vehicle 100 includes an FC module 10, an inverter device 72, a motor 70, a power transmission system 74, and a PTO shaft 76. The DC voltage of the power generated in the FC stack 11 of the FC module 10 is boosted by the boost circuit 40 and then supplied to the inverter device 72. The inverter device 72 converts the DC voltage into, for example, a three-phase AC voltage and supplies it to the motor 70. The inverter device 72 has a bridge circuit (hereinafter also referred to as an “inverter circuit”) including a plurality of power transistors. The motor 70 includes a rotating rotor and a stator with a plurality of coils electrically connected to the inverter device 72. The rotor is coupled to the output shaft 71, for example, via a reduction gear (speed reducer) or directly. The motor 70 rotates the output shaft 71 with torque and rotational speed controlled according to the waveform of the three-phase AC voltage from the inverter device 72.

The inverter device 72 shown in FIG. 4 includes an ECU 73 configured or programmed to control the motor 70. The ECU 73 is configured or programmed to control the switching operation (turn-on or turn-off) of each of the plurality of power transistors included in the bridge circuit of the inverter device 72. The ECU 73 may be connected to the plurality of power transistors in the bridge circuit via pre-drivers (which may be referred to as “gate drivers”). The ECU 73 may be configured or programmed to operate under the control of a higher-level computer such as the controller 60.

The torque of the output shaft 71 of the motor 70 is transmitted to the power transmission system 74. The power transmission system 74 operates with the motor 70 as the power source and drives the wheels 104R and 104F shown in FIG. 1, and/or the PTO shaft 76. This power transmission system 74 may have a structure similar or analogous to the power transmission system in conventional tractors equipped with internal combustion engines such as diesel engines. By adopting a power transmission system used in agricultural tractors, for example, it is possible to reduce the design and manufacturing costs for producing an agricultural work vehicle 100 including an FC power generation system. The power transmission system 74 includes a travel power transmission mechanism to transmit power from the motor 70 to the left and right rear wheels 104R through a clutch, transmission, and rear wheel differential device, and a PTO power transmission mechanism that transmits power from the motor 70 to the PTO shaft 76. The power transmission system 74 includes a PTO clutch that switches between a state in which power is transmitted from the motor 70 to the PTO shaft 76 (engaged state) and a state in which it is not transmitted (disengaged state). The PTO clutch may be manually operated by the driver through the operation of an operation device, or switched by automatic control. The transmission case 102B in FIG. 1 may be divided into a front case (mission case) housing clutches such as the PTO clutch and transmission and a rear case (differential gear case) housing the rear wheel differential device. The rear case may also be referred to as a rear axle case.

The work vehicle 100 includes a secondary battery (battery pack) 80 that temporarily stores electrical energy generated by the FC module 10. An example of the battery pack 80 includes a pack of lithium-ion batteries. The battery pack 80 is electrically connected to the FC module 10 and electrically connected to the motor 70 via the inverter device 72. The battery pack 80 can supply power to the inverter device 72 at the necessary timing in cooperation with the FC module 10 or independently. Various battery packs used in electric passenger vehicles may be adopted as the battery pack 80. Hereinafter, the battery pack 80 may be simply referred to as “battery 80”.

The work vehicle 100 includes various electrical equipment (onboard electronic components) that operates on electricity, in addition to the motor 70 and the inverter device 72. Examples of electrical equipment include electromagnetic valves such as open/close valves 20, air cooling fans of the radiator device 34, electric pumps of air conditioning compressors 85, and temperature controllers for heating or cooling the FC stack 11. The temperature controllers include electric heaters 86. A first and a second DC-DC converter 81 and 82 to obtain appropriate power supply voltages for the operation of electrical equipment, and storage batteries 83 may also be included in the electrical equipment. Furthermore, various electronic components not shown (such as lamps, electric motors for hydraulic systems) may be included in the electrical equipment. The electrical equipment may be electronic components similar to electrical equipment installed in conventional agricultural tractors.

In the example of FIG. 3, the first DC-DC converter 81 is a circuit that steps down the voltage output from the boost circuit 40 of the FC module 10 to a first voltage, for example, 12 volts. The storage battery 83 is, for example, a lead-acid battery and stores electrical energy at the voltage output from the first DC-DC converter 81. The storage battery 83 may be used as a power source for various electrical equipment such as lamps.

The work vehicle 100 shown in FIG. 3 includes not only the first DC-DC converter 81 but also a second DC-DC converter 82 as a voltage conversion circuit that steps down the high voltage output by the FC module 10. The second DC-DC converter 82 is a circuit that steps down the voltage output from the boost circuit 40 of the FC module 10 (for example, several hundred volts) to a second voltage higher than the first voltage, for example, 24 volts. The air cooling fan of the radiator device 34, for example, is configured to operate on the voltage output from the second DC-DC converter 82. Note that although the radiator device 34 is described as a single component in FIG. 3, one work vehicle 100 may include a plurality of radiator devices 34. Additionally, the electric pump of the air conditioning compressor 85 and the electric heater 86 are configured to operate on the voltage output from the second DC-DC converter 82.

The work vehicle 100 shown in FIG. 3 includes a temperature controller configured or programmed to cool or heat the FC stack 11 included in the FC power generation system. The operation of the temperature controller or alike requires relatively large power. The relatively high 24-volt voltage output by the second DC-DC converter 82 is applied to the temperature controller. In this example embodiment, the temperature controller includes the radiator device 34 that releases heat from the coolant cooling the FC stack 11, and the relatively high 24-volt voltage (second voltage) output by the second DC-DC converter 82 is applied to the radiator device 34. The temperature controller includes a heater 86 that heats the FC stack 11. The relatively high voltage output by the second DC-DC converter 82 may also be applied to the heater. The relatively high voltage output by the second DC-DC converter 82 may also be applied to air conditioning devices such as the air conditioning compressor 85.

The work vehicle 100 may include a third voltage conversion circuit that converts the high voltage output by the FC module 10 to a third voltage higher than the second voltage. The third voltage is, for example, 48 volts. If the work vehicle 100 includes another motor in addition to the motor 70, for example, the third voltage may be used as the power source for such other motors.

In an agricultural work vehicle including a fuel cell power generation system, in addition to the electrical equipment necessary for agricultural task, the agricultural work vehicle also includes electrical equipment necessary for the operation of fuel cell power generation, so the appropriate voltage magnitude may differ for each electrical equipment. According to the example embodiments of this disclosure, it is possible to supply voltages of appropriate magnitudes.

In the example shown in FIG. 3, a plurality of fuel tanks 50 are housed in a single tank case 51. The fuel tank 50 is connected to a supplying port (fueling port) 52 through which fuel is supplied from the outside. This connection is made via piping 21 for flowing fuel gas. The fuel tank 50 is also connected to the FC module 10 via piping 21, which is equipped with an open/close valve 20. When hydrogen is used as the fuel gas, the piping 21 may be formed from materials with high resistance to hydrogen embrittlement, such as austenitic stainless steel like SUS316L.

A valve space 53 is provided in the tank case 51, and various valves including a pressure reducing valve are placed in this valve space 53. Through various valves provided in the valve space 53, the piping 21 connects the fuel tank 50 and the FC module 10. Fuel gas with reduced pressure by the pressure reducing valve flows through the piping 21 connecting the tank case 51 and the FC module 10. When the fuel gas is hydrogen gas, high-pressure hydrogen gas of, for example, 35 megapascals or more may be supplied in the fuel tank 50, but the hydrogen gas after passing through the pressure reducing valve may be reduced to about 2 atmospheres or less.

Next, refer to FIG. 4. In addition to what is shown in FIG. 3, FIG. 4 shows a plurality of ECUs that communicate within the work vehicle 100 and a user interface 1. Communication can be executed via CAN bus wiring and other similar communication pathways, which function as paths for electrical signals (thin solid lines). FIG. 4 also shows a cooling system to perform thermal management of components. Specifically, the paths of coolant (dotted lines) are schematically shown.

As mentioned above, the first and second DC-DC converters 81 and 82 are configured to output voltages of different magnitudes. ECUs are also provided for these first and second DC-DC converters 81 and 82 to control each voltage conversion circuit. These ECUs, like other ECUs, are applied the relatively low first voltage output by the first DC-DC converter 81.

In the example of FIG. 4, the work vehicle 100 includes a cooling system in which coolant circulates via coolant pumps 31A and 31B. These coolant pumps 31A and 31B are provided inside the FC module 10. The cooling system in this example includes a first radiator device 34A responsible for cooling the FC stack 11 and a second radiator device 34B to cool other electrical equipment. The cooling system includes a flow path (first flow path) where coolant flows between the FC stack 11 and the first radiator device 34A. Furthermore, this cooling system includes a flow path (second flow path) where coolant flows between electrical equipment including the motor 70 and the second radiator device 34B. In the example of FIG. 4, for instance, a heater core 87 used to heat the cabin is provided, and the coolant flowing through the first radiator device 34A flows through the heater core 87.

The user interface 1 includes an operation device 2 such as an accelerator pedal (or accelerator lever), a main meter 4, and an FC meter 6. The work vehicle 100 shown in FIG. 4 further includes a controller 60 and a storage device 7. The controller 60 includes a main ECU 3 and an FC system ECU 5.

The main ECU 3 is connected to the FC system ECU 5, the operation device 2, the main meter 4, and the storage device 7. The main ECU 3 controls the overall operation of the work vehicle 100. The main meter 4 may display various parameters that identify the travel state or operating state of the work vehicle 100. The FC system ECU 5 controls the operation of the FC power generation system. The FC system ECU 5 is connected to the FC meter 6. The FC meter 6 displays various parameters that identify the operating state of the FC power generation system.

The storage device 7 includes one or more storage media such as flash memory or magnetic disks. The storage device 7 stores various data generated by the main ECU 3 and FC system ECU 5. The storage device 7 also stores computer programs that cause the main ECU 3 and FC system ECU 5 to perform desired operations. The computer programs may be provided to the work vehicle 100 via storage media (e.g., semiconductor memory or optical discs) or telecommunication lines (e.g., the Internet). The computer programs may be sold as commercial software.

The cells of the battery pack 80 are controlled by a Battery Management Unit (BMU). The BMU includes circuits and a CPU (Central Processing Unit) that perform voltage monitoring for each cell of the battery, monitoring of overcharging and over-discharging, and cell balance control. These circuits and CPU may be mounted on a battery controller board.

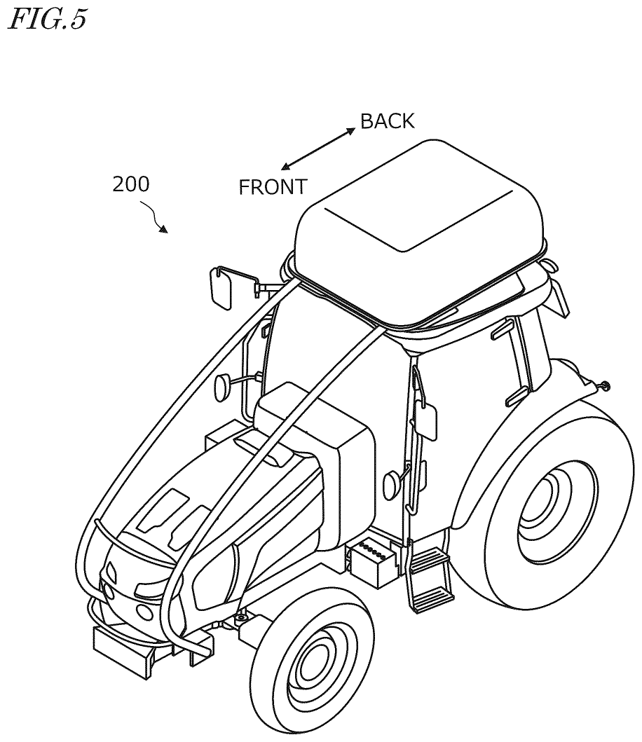

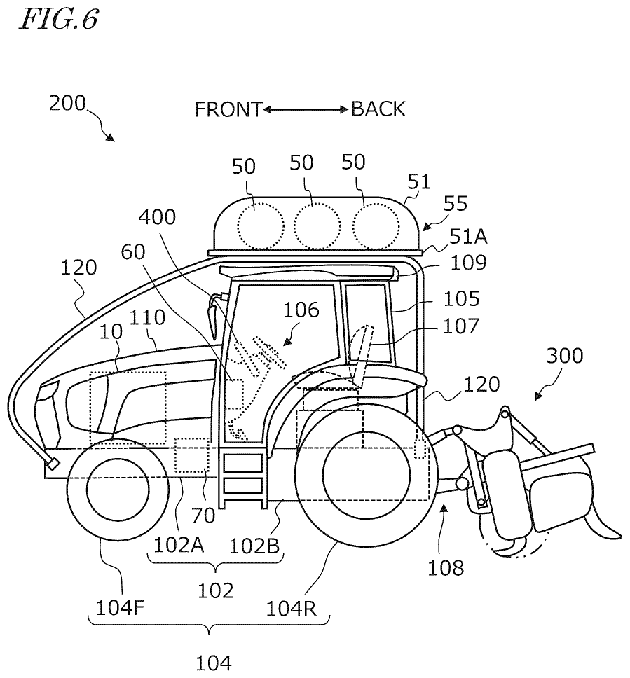

Next, referring to FIG. 5 and FIG. 6, a basic configuration of an example embodiment of the work vehicle according to this disclosure will be described. FIG. 5 is a perspective view schematically showing an example of the configuration of the work vehicle 200 in this example embodiment. FIG. 6 is a side view schematically showing an example of the configuration of the work vehicle 200 in this example embodiment.

As shown in FIG. 6, the work vehicle 200 in this example embodiment includes an FC module 10, a fuel tank 50, a motor 70, a driver seat 107, an operation terminal 400, a controller 60, a travel device including wheels 104, and a vehicle frame 102. The work vehicle 200 has a configuration similar to the configuration of the work vehicle 100 described with reference to FIG. 1. The controller 60 may be configured or programmed to include a main ECU 3 and an FC system ECU 5 as shown in FIG. 4. The controller 60 may be configured or programmed to control the operation of the work vehicle 200 by issuing commands to other ECUs such as the ECU 73 in the inverter device 72 and the ECU 42 in the FC module 10. Each ECU includes a storage device (ROM) and may further include a processing circuit (or processor) such as s an FPGA (Field Programmable Gate Array) and/or GPU (Graphics Processing Unit). Each ECU executes a computer program describing a group of instructions to execute at least one process stored in the storage device, either alone or in cooperation with other ECUs through communication, to perform desired operations.

The operation terminal 400 is a terminal for the user to execute operations related to the travel of the work vehicle 200 and the operation of the implement 300, and is also referred to as a virtual terminal (VT). The operation terminal 400 may include a touch screen type display device and/or one or more buttons. The display device may be, for example, a display such as a liquid crystal display or an organic light-emitting diode (OLED) display. By operating the touch screen of the operation terminal 400, users can perform various operations such as inputting information regarding the type of implement 300 and/or type of work, changing values of controlled variables for the work vehicle 200 such as vehicle speed or engine rotation speed, switching the power of the work vehicle on/off, and switching the implement on/off. The operation terminal 400 may be configured to be detachable from the work vehicle 200. A user at a location away from the work vehicle 200 may control the operation of the work vehicle 200 by operating the detached operation terminal 400.

The work vehicle 200 may further include at least one sensor to sense the environment around the work vehicle 200, and a processor configured or programmed to process sensor data output from the at least one sensor. The sensor may include, for example, a plurality of cameras, a LiDAR sensor, and a plurality of obstacle sensors. The sensor data output from the sensor may be used for obstacle detection and positioning, for example. Various ECUs mounted on the work vehicle 200 may be configured or programmed to cooperatively perform calculations and control to achieve autonomous driving based on the sensor data output from the sensor.

In this example embodiment, the fuel tank 50 is supported by a mounting frame 120. The mounting frame 120 is fixed to the vehicle frame 102 across the driver seat 107. The fuel tank 50 is located above the driver seat 107. However, the installation location of the fuel tank 50 is not limited to the illustrated example and may be, for example, inside the front housing 110.

In this example embodiment, the mounting frame 120 is an elongated structure, such as a pipe, fixed to the vehicle frame 102. The mounting frame 120 includes two frames positioned on the left and right sides of the work vehicle 200 (refer to FIG. 5). The front portion of the mounting frame 120 has a curved shape. However, the shape of the mounting frame 120 shown is just an example, and the shape of the mounting frame 120 is not limited to this example.

In this example embodiment, the vehicle frame 102 includes a front frame 102A that rotatably supports the front wheels 104F and a transmission case 102B that rotatably supports the rear wheels 104R. One end (front end) of the mounting frame 120 is fixed to the front frame 102A. The other end (rear end) of the mounting frame 120 is fixed to the transmission case 102B. These fixations may be done by appropriate methods such as welding or bolt joining, depending on the material of the mounting frame 120. The mounting frame 120 may be formed from metal, synthetic resin, carbon fiber, or composite materials such as carbon fiber reinforced plastic or glass fiber reinforced plastic. The transmission case 102B includes a rear axle case, and the rear end of the mounting frame 120 may be fixed to the rear axle case. When the mounting frame 120 is formed from metal, a portion or entirety of its surface may be covered with synthetic resin.

As shown in FIG. 6, the work vehicle 200 includes a cabin 105 that surrounds the driver seat 107 between the vehicle frame 102 and the mounting frame 120. The driver seat 107 is located in the rear portion of the interior of the cabin 105. In front of the driver seat 107, for example, a steering wheel 106 is provided to change the direction of the front wheels 104F. The cabin 105 includes a cabin frame that defines its skeleton. A roof 109 is provided on the upper portion of the cabin frame. The cabin frame in this example embodiment is a 4-pillar style. The cabin 105 is supported by the transmission case 102B of the vehicle frame 102, for example, via vibration-isolating mounts. The interface 1 explained with reference to FIG. 4 is provided inside the cabin 105. Since the cabin 105 does not directly support the fuel tank 50, there is no need to specially increase its strength, and a cabin that has been used in conventional tractors can be adopted.

The work vehicle 200 includes a placement platform 51A that connects the left frame 120 and the right frame 120. The fuel tank 50 can be positioned on the placement platform 51A. When there are a plurality of fuel tanks 50, the plurality of fuel tanks 50 may be provided in a fuel tank module 55. As shown in FIG. 6, the fuel tank module 55 includes a tank case 51 that houses a plurality of fuel tanks 50. The left and right mounting frames 120 may be connected to each other by structural elements other than the placement platform 51A.

A linkage device 108 is provided at the rear end of the transmission case 102B, which forms the rear portion of the vehicle frame 102. The linkage device 108 includes, for example, a three-point linkage device (referred to as a “three-point link” or “three-point hitch”), a PTO shaft, a universal joint, and a communication cable. The implement 300 can be attached to or detached from the work vehicle 200 using the linkage device 108. The linkage device 108 can, for example, raise and lower the three-point link by a hydraulic device to change the position or posture of the implement 300. Additionally, power can be transmitted from the work vehicle 200 to the implement 300 via the universal joint. The work vehicle 200 can execute predetermined work (agricultural task) with the implement 300 while pulling the implement 300. The linkage device 108 may be provided on the front portion of the vehicle frame 102, in which case the implement 300 can be connected to the front of the work vehicle 200.

The implement 300 may include, for example, a drive device, a controller, and a communication device. The drive device performs operations necessary for the implement 300 to execute predetermined tasks. The drive device includes devices appropriate for the application of the implement 300, such as hydraulic devices, electric motors, or pumps. The controller is configured or programmed to control the operation of the drive device. The controller is configured or programmed to cause the drive device to perform various operations in response to signals transmitted from the work vehicle 200 via the communication device. Signals corresponding to the state of the implement 300 may also be transmitted from the communication device to the work vehicle 200.

The implement 300 shown in FIG. 6 is a rotary tiller, but the implement 300 is not limited to a rotary tiller. For example, any implement such as a seeder, a spreader, a transplanter, a mower, rake, baler, harvester, sprayer, or harrow can be connected to and used with the work vehicle 200.

The work vehicle 200 shown in FIG. 6 is capable of manned operation, but it may also be configured only for unmanned operation. In that case, components necessary only for manned operation, such as the cabin 105, steering wheel 106, and driver seat 107, may not be provided on the work vehicle 200. An unmanned work vehicle 200 can travel autonomously or by remote control by a user.

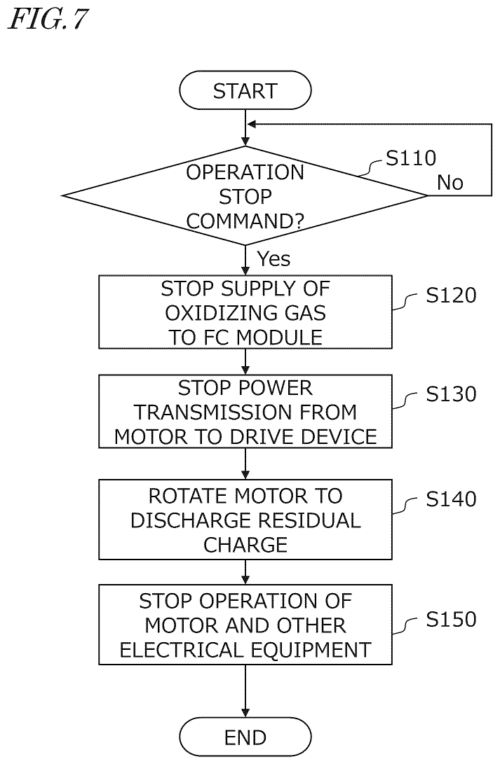

The controller 60 of the work vehicle 200 is configured or programmed to, when a command to stop the operation of the work vehicle 200 is issued, stop the operation of the FC module 10 and perform a discharge process to consume residual charge in the circuitry within the system. The following describes an example of this process with reference to FIG. 7.

FIG. 7 is a flowchart showing an example of the operation of the controller 60 when stopping the operation of the work vehicle 200. The controller 60 is configured or programmed to stop the operation of the work vehicle 200 by executing the operations of steps S110 to S150 shown in FIG. 7 during the operation of the work vehicle 200.

In step S110, the controller 60 determines whether an operation stop command has been issued or not. The operation stop command is a command to stop power supply to each electrical equipment of the work vehicle 200 and power generation by the fuel cell. The operation stop command may be issued, for example, when a user turns off a power switch (e.g., an ignition switch) included in the operation device 2. When the operation stop command is issued, the process proceeds to step S120.

In step S120, the controller 60 stops the supply of oxidizing gas (e.g., air) to the FC module 10. Specifically, the FC system ECU 5 of the controller 60, in response to the operation stop command, instructs the ECU 42 of the FC module 10 to close the shut-off valve 17 (see FIG. 2). Accordingly, the flow of oxidizing gas into the FC stack 11 is blocked and power generation is stopped. In this example embodiment, the supply of oxidizing gas to the FC stack 11 is stopped, but the system may be configured to stop the supply of fuel (hydrogen gas in this example embodiment) instead. In step S120, the controller 60 also stops the operation of the air compressor 12.

Next, in step S130, the controller 60 halts power transmission from the motor 70 to the traveling device. Specifically, the main ECU 3 of the controller 60 switches a plurality of clutches in the power transmission system 74 from the engaged state to the disengaged state, so as to halt power transmission from the motor 70 to the traveling device including the axles and wheels 104. In this process, the main ECU 3 may maintain power transmission from the motor 70 to the PTO shaft 76 by keeping the PTO clutch in the engaged state, or may stop power transmission from the motor 70 to the PTO shaft 76 by switching the PTO clutch to the disengaged state.

Next, in step S140, the controller 60 rotates the motor 70 to discharge residual electric charge in the circuitry connected to the motor 70. Specifically, the main ECU 3 in the controller 60 consumes the residual charge by issuing a command to the ECU 73 in the inverter device 72 to rotate the motor 70. In this process, although the motor 70 rotates, the traveling device remains stopped because power transmission from the motor 70 to the traveling device is stopped. If power transmission from the motor 70 to the PTO shaft 76 is maintained, the PTO shaft 76 also rotates with the rotation of the motor 70. Rotating the PTO shaft 76, a larger amount of energy can be consumed compared to when the PTO shaft 76 is not rotated. This shortens the time required for discharge. On the other hand, when power transmission from the motor 70 to the PTO shaft 76 is stopped, the PTO shaft 76 does not rotate even when the motor 70 rotates. In this case, while the energy consumed is relatively small, the implement 300 connected to the PTO shaft 76 can be prevented from being unnecessarily driven when stopping the operation of the work vehicle 200.

When the discharge of residual charge is completed, the process proceeds to step S150, and the controller 60 stops the operation of the motor 70 and other electrical equipment. Accordingly, the work vehicle 200 stops operation.

The discharge process described above consumes the residual charge in the circuitry connected to the motor 70. The circuitry connected to the motor 70 includes, for example, the bridge circuit in the inverter device 72 shown in FIG. 4, the boost circuit 40, and the DC-DC converters 81 and 82. The boost circuit 40 functions as a boost converter that boosts the DC voltage generated by the FC stack 11. The bridge circuit in the inverter device 72 functions as an inverter that converts the DC voltage output from the boost converter into AC voltage and supplies it to the motor 70. These circuits may include a plurality of capacitors. The discharge process enables discharging the residual charge remaining in these capacitors, thus preventing unnecessary charge from remaining in the circuits when the work vehicle 200 is in a power-off state.

In the discharge process of step S140, the controller 60 may perform discharge of residual charge not only by rotating the motor 70 but also by operating other electrical equipment or charging the battery 80. For example, after stopping the supply of fuel or oxidizing gas to the FC module 10, the controller 60 may rotate an air cooling fan in the radiator device 34A to cool the FC stack 11 shown in FIG. 4 to discharge residual charge in the circuits within the FC module 10. By rotating not only the motor 70 but also the cooling fan to cool the FC module 10, the discharge of residual charge in the FC module 10 can be effectively executed. Additionally, in response to the operation stop command, the controller 60 may discharge residual charge remaining in the DC-DC converter 81 and other components by rotating a cooling fan in the radiator device 34B to cool electrical equipment other than the FC stack 11. Furthermore, the controller 60 may be configured or programmed to consume residual charge more efficiently by operating a hydraulic system including a hydraulic pump. However, when operating the hydraulic pump, a hydraulic lock mechanism may be used to prevent the lift arm in the linkage device 108 and other components from operating.

As shown in FIGS. 3 and 4, the work vehicle 200 according to this example embodiment may include a first switch R1 provided in the current path between the FC module 10 and the motor 70. The work vehicle 200 may further include a second switch R2 provided in the current path between the battery 80 and the motor 70. The first switch R1 and the second switch R2 may be, for example, relays. The on/off control of each of the first switch R1 and the second switch R2 may be performed by the main ECU 3 in the controller 60. By turning off the first switch R1, power supply from the FC module 10 to the motor 70 is cut off. By turning off the second switch R2, power supply from the battery 80 to the motor 70 is cut off.

In response to the operation stop command, the controller 60 may turn off the first switch R1 and then may perform discharge of residual charge by rotating the motor 70 or operating other electrical equipment. In this process, the controller 60 may operate other electrical equipment such as cooling fans in the radiator devices 34A and 34B. By turning off the first switch R1, discharge of residual charge can be executed while cutting off power supply from the FC module 10 to the motor 70. The controller 60 may turn off both the first and second switches in response to the operation stop command, and then may also perform discharge of residual charge by rotating the motor 70 or operating other electrical equipment. This allows the discharge of residual charge to be performed while the power supply from the FC module 10 and the battery 80 to the motor 70 is cut off.

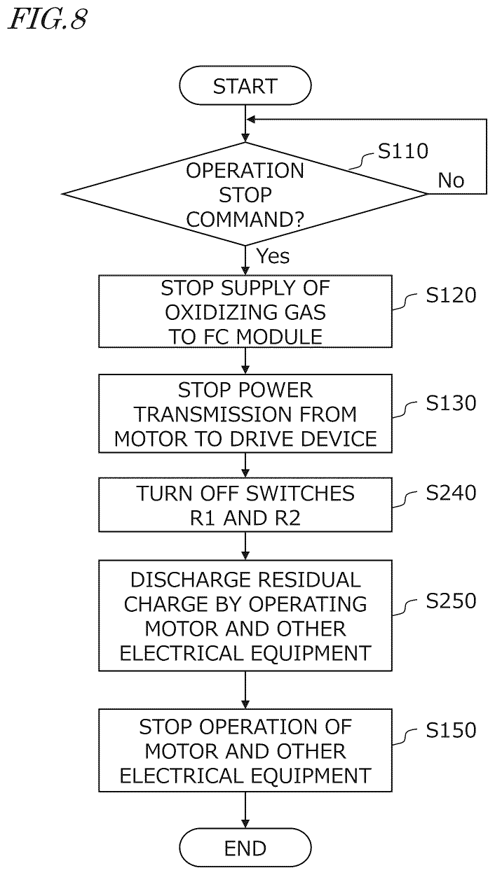

FIG. 8 is a flowchart showing an example of an operation that performs discharge of residual charge by operating the motor and other electrical components with switches R1 and R2 turned off. The flowchart shown in FIG. 8 is similar to that in FIG. 7, except that step S140 in FIG. 7 is replaced with steps S240 and S250. In the example of FIG. 8, after stopping power transmission from the motor 70 to the traveling device in step S130, the process proceeds to step S240, where the controller 60 turns off the first switch R1 and the second switch R2. Next, in step S250, the controller 60 operates the motor 70 and other electrical equipment (e.g., cooling fans in radiator devices 34A and 34B, hydraulic system, and/or electric pumps, etc.) to execute discharge of residual charge. This operation allows efficient performance of discharge in the peripheral circuits of the motor 70 and the circuits within the FC module 10.

The controller 60 may change the discharge process depending on whether an implement 300 is connected to the PTO shaft 76 or not. For example, when an implement 300 is connected to the PTO shaft 76, the controller 60 may rotate the motor 70 while stopping power transmission from the motor 70 to the PTO shaft 76, and when no implement is connected to the PTO shaft 76, it may rotate the motor 70 while maintaining power transmission from the motor 70 to the PTO shaft 76. Such control allows appropriate switching of the discharge method depending on the presence or absence of the implement 300.

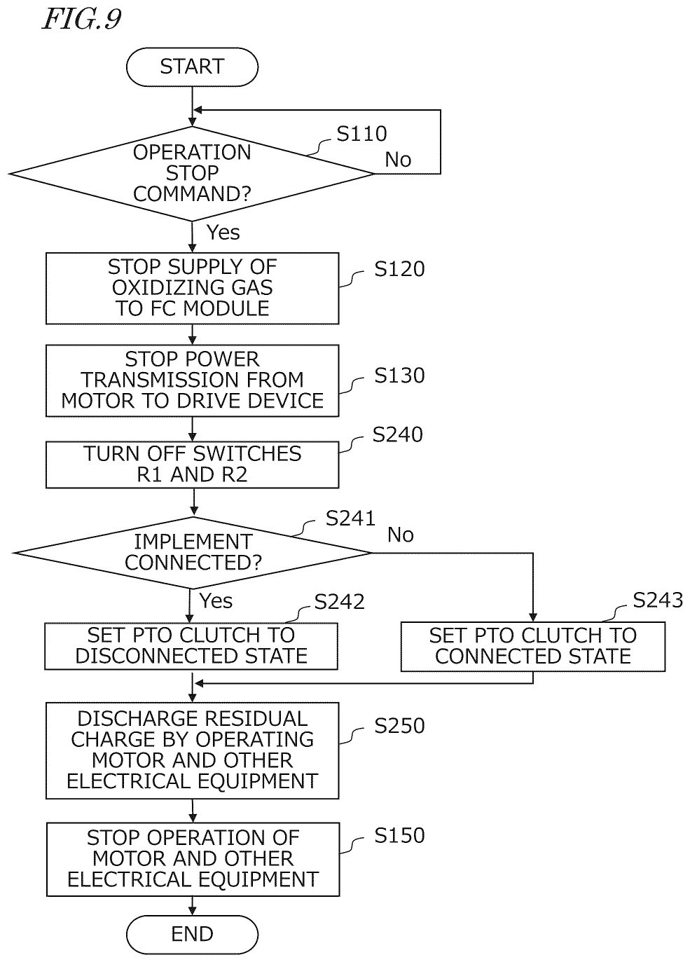

FIG. 9 is a flowchart showing an example of an operation that changes the discharge process depending on whether an implement 300 is connected to the PTO shaft 76 or not. The flowchart shown in FIG. 9 is the same as the example shown in FIG. 8, except that steps S241, S242, and S243 are added between steps S240 and S250 in FIG. 8. In the example of FIG. 9, after turning off the switches R1 and R2 in step S240, the controller 60 determines whether an implement is connected to the PTO shaft 76 or not. Whether an implement 300 is connected to the PTO shaft 76 may be determined based on, for example, a signal transmitted from the implement 300 to the work vehicle 200. When an implement is connected, the process proceeds to step S242. When an implement is not connected, the process proceeds to step S243.

In step S242, the controller 60 sets the PTO clutch to a disengaged state. This stops power transmission from the motor 70 to the PTO shaft 76.

In step S243, the controller 60 sets the PTO clutch to an engaged state. This maintains power transmission from the motor 70 to the PTO shaft 76.

In step S250 thereafter, the controller 60 operates the motor 70 and other electrical components to perform discharge of residual charge. Then, in step S150, the operation of the motor 70 and other electrical equipment is stopped. This stops the operation of the work vehicle 200.

According to the control shown in FIG. 9, when the implement 300 is connected to the work vehicle 200, unnecessary activation of the implement 300 due to the rotation of the PTO shaft 76 can be avoided when the work vehicle 200 is stopped. On the other hand, when the implement 300 is not connected to the work vehicle 200, rotating the PTO shaft increases energy consumption, allowing the discharge to be performed more efficiently. Thus, an appropriate discharge method can be selectively executed depending on whether the implement 300 is connected.

In the above example embodiments, the discharge process is performed when a command to turn off the power of the work vehicle 100 is issued. The discharge process may be performed not only at the timing of turning off the power, but also, for example, when a command for idle stop (temporary stop of the FC module 10) is issued. Performing the discharge process during the idle stop can reduce or prevent degradation of the fuel cell.

The configurations and operations of the above example embodiments are exemplary, and the present disclosure is not limited to the above example embodiments. For example, various example embodiments may be appropriately combined to configure other example embodiments.

The example embodiments and techniques in the present disclosure are applicable to work vehicles such as agricultural tractors, harvesters, rice planters, vehicles for crop management, and vegetable transplanters.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A work vehicle comprising:
a fuel cell module including a fuel cell stack;
at least one fuel tank to store fuel to be supplied to the fuel cell stack;
a motor connected to the fuel cell module;
a travel device drivable by the motor;
a power take-off shaft drivable by the motor and configured to connect to an implement; and
a controller configured or programmed to:
in response to an operation stop command, stop supply of the fuel or oxidizing gas to the fuel cell stack, and thereafter rotate the motor with power from the motor to the travel device halted, so as to discharge residual electric charge in circuitry connected to the motor.

2. The work vehicle according to claim 1, wherein the controller is configured or programmed to perform discharging by rotating the motor while maintaining power transmission from the motor to the power take-off shaft.

3. The work vehicle according to claim 1, wherein the controller is configured or programmed to perform discharging by rotating the motor with power from the motor to the power take-off shaft halted.

4. The work vehicle according to claim 1, further comprising:
a first switch provided on a current path between the fuel cell module and the motor; wherein
the controller is configured or programmed to, in response to the operation stop command, turn off the first switch and thereafter perform discharging by rotating the motor.

5. The work vehicle according to claim 4, further comprising:
a battery to be connected to the fuel cell module and the motor; and
a second switch provided on a current path between the battery and the motor; wherein
the controller is configured or programmed to, in response to the operation stop command, turn off the first switch and the second switch, and thereafter perform discharging by rotating the motor.

6. The work vehicle according to claim 1, wherein the circuitry includes:
a boost converter to boost a DC voltage generated by the fuel cell stack; and
an inverter to convert the DC voltage output from the boost converter to an AC voltage and supply the AC voltage to the motor.

7. The work vehicle according to claim 1, further comprising:
a cooling fan to cool the fuel cell module;
the controller is configured or programmed to, after stopping the supply of the fuel or oxidizing gas to the fuel cell module in response to the operation stop command, further rotate the cooling fan to discharge residual electric charge in the fuel cell module.

8. The work vehicle according to claim 1, wherein the work vehicle is an agricultural machine.

9. A controller for a work vehicle that includes a fuel cell module with a fuel cell stack, at least one fuel tank to store fuel to be supplied to the fuel cell stack, a motor connected to the fuel cell module, a travel device drivable by the motor, and a power take-off shaft drivable by the motor and configured to connect to an implement, the controller being configured or programmed to, in response to an operation stop command, stop supply of the fuel or oxidizing gas to the fuel cell module, and thereafter rotate the motor with power from the motor to the travel device halted, so as to discharge residual electric charge in circuitry connected to the motor.

10. A control method for a work vehicle that includes a fuel cell module with a fuel cell stack, at least one fuel tank to store fuel to be supplied to the fuel cell stack, a motor connected to the fuel cell module, a travel device drivable by the motor, and a power take-off shaft drivable by the motor and configured to connect to an implement, the control method comprising:
in response to an operation stop command, stopping supply of the fuel or oxidizing gas to the fuel cell module; and
after stopping the fuel supply, rotating the motor with power from the motor to the travel device halted, so as to discharge residual charge in circuitry connected to the motor.
